(19) United States
(12) Patent Application Publication
(10) Pub. No.: US 2025/0166212 A1
(43) Pub. Date: May 22, 2025

(54) IMAGE PROCESSING APPARATUS AND METHOD

(71) Applicant: Realtek Semiconductor Corporation, Hsinchu (TW)

(72) Inventors: Chung-Ping YU, Hsinchu (TW); Hsin Chieh WANG, Hsinchu (TW)

(21) Appl. No.: 18/818,609

(22) Filed: Aug. 29, 2024

(30) Foreign Application Priority Data
Nov. 17, 2023 (TW) 112144544

(51) Int. Cl. G06T 7/246; G06T 3/4007; G06T 5/50

(52) U.S. Cl. CPC G06T 7/248; G06T 3/4007; G06T 5/50

(57) ABSTRACT

An image processing apparatus is configured to execute the following steps. A first motion estimation is performed on a down-sized current frame and a down-sized reference frame to generate first motion vectors and a first reliability corresponding to the first motion vectors. An n-th motion estimation is performed on a current frame and a reference frame based on the first motion vectors and the first reliability to generate n-th motion vectors and a n-th reliability corresponding to the n-th motion vectors. A compensated frame between the current frame and the reference frame is generated based on the n-th motion vectors and the n-th reliability.

### CROSS-REFERENCE TO RELATED APPLICATION

This application claims priority to Taiwan Application Serial Number 112144544, filed Nov. 17, 2023, which is herein incorporated by reference in its entirety.

### BACKGROUND

### Field of Invention

The present disclosure relates to an image processing apparatus and method. More particularly, the present disclosure relates to an image processing apparatus and method for motion estimations and motion compensations.

### Description of Related Art

In the field of image processing, when a frame rate conversion (FRC) is performed, it may first calculate motion vectors through a motion estimation process and continue by handing over to a motion compensation process in order to generate an interpolated frame between two original frames. This conversion may create smoother video streams.

However, when the motion compensation is performed, if there are repetitive patterns in the frame, such as blinds, striped shirts, windows of office buildings, containers at the dock, etc., misjudgments may occur in motion estimation and lead to periodic broken or repeat broken, thereby generating the wrong motion vector. When the misjudgments occur, unnatural fragmented patterns will appear in the frame, resulting in a degraded viewing experience. Furthermore, the computational burden will increase if periodic patterns of various sizes and ranges need to be detected in order to detect whether repetitive patterns appear in frames.

However, when performing motion compensation, there is a lack of a motion vector evaluation mechanism to evaluate the reliability of the motion vectors. Therefore, when the reliability of the motion vectors is too low, it will further cause misjudgments in the motion compensation, resulting in image broken, edge shaking, or judder situation.

In view of this, how to balance the calculation cost and accuracy for motion vector estimation is the goal that the industry strives to work on.

### SUMMARY

The disclosure provides an image processing apparatus comprising a storage and a processor. The storage is configured to store a current frame and a reference frame. The processor is coupled to the storage and configured to execute the following operations. The processor is configured to downsize the current frame and the reference frame to generate a down-sized current frame and a down-sized reference frame respectively. The processor is further configured to perform a first motion estimation on the down-sized current frame and the down-sized reference frame to generate a plurality of first motion vectors and a first reliability corresponding to the first motion vectors. The processor is further configured to perform an n-th motion estimation on the current frame and the reference frame based on the first motion vectors and the first reliability to generate a plurality of n-th motion vectors and a n-th reliability corresponding to the n-th motion vectors. The processor is further configured to generate a compensated frame between the current frame and the reference frame based on the n-th motion vectors and the n-th reliability.

The disclosure further provides an image processing method being adapted for use in an electronic apparatus. The image processing method comprises the following steps: downsizing a current frame and a reference frame to generate a down-sized current frame and a down-sized reference frame respectively; performing a first motion estimation on the down-sized current frame and the down-sized reference frame to generate a plurality of first motion vectors and a first reliability corresponding to the first motion vectors; performing an n-th motion estimation on the current frame and the reference frame based on the first motion vectors and the first reliability to generate a plurality of n-th motion vectors and a n-th reliability corresponding to the n-th motion vectors; and generating a compensated frame between the current frame and the reference frame based on the n-th motion vectors and the n-th reliability.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a motion estimation operation and a motion compensation operation generating a compensated frame between two frames according to some embodiments of the present disclosure.

FIG. 2 is a schematic diagram illustrating an image processing apparatus according to an embodiment of the present disclosure.

FIG. 3 is a schematic diagram illustrating a motion estimation operation according to an embodiment of the present disclosure.

FIG. 4 is a schematic diagram illustrating an operation of downsizing frames according to an embodiment of the present disclosure.

FIG. 5 is a flow diagram illustrating an image processing method according to an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

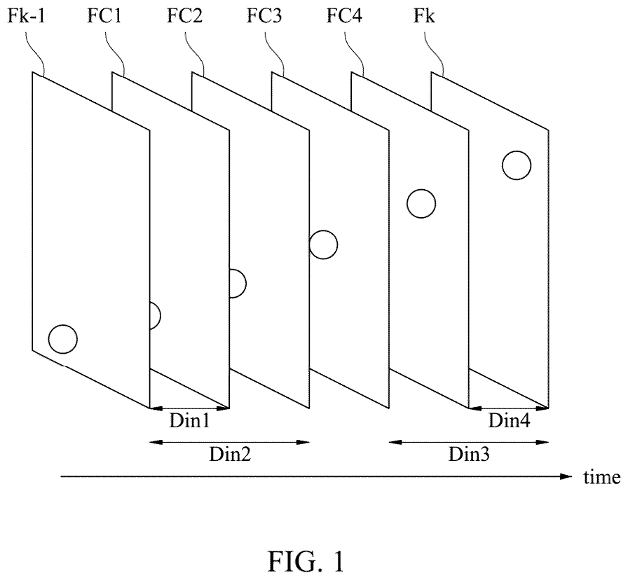

Motion estimations and motion compensations are used for generating an interpolated frame between two frames to increase frame rates. For example, please refer to FIG. 1, frames Fk-1 and Fk are two adjacent frames in a video, and the operations of motion estimations and motion compensations are used for generating the interpolated frames FC1-FC4 between the frames Fk-1 and Fk. In the motion estimations, the frames Fk-1 and Fk can be segmented into i*j blocks, and a best motion vector of each of the blocks can be calculated through 3D recursive searching.

More specifically, the 3D recursive searching comprises multiple scan operations. Each of the scan operations generates multiple motion vector candidates in the range of a search window based on an initial vector and features of image changing for each of the blocks. One of the candidate motion vectors with the highest suitability can be selected as the motion vector of the block from candidate motion vectors such as a zero vector, a spatial vector, a temporal vector, and a global vector. Next, when performing the scan operation again, the initial vector can be calculated as the motion vectors of every block from the last scan operation adding a random vector. Accordingly, the optimal motion vector (e.g., motion vectors MV1-MVn described later) of each of the blocks is able to be converged through multiple scan operations.

Next, the motion compensation generates the interpolated frames FC1-FC4 between the frames Fk-1 and Fk based on the frames Fk-1 and Fk and the optimal motion vector of each of the blocks. For example, if the optimal motion vector is roughly the vector from lower left to upper right, the circles in the interpolated frames FC1-FC4 will be arranged from lower left to upper right sequentially based on the circle in the lower left corner in the frame Fk-1 and the circle in the upper right corner in the frame Fk. Namely, the interpolated frames FC1-FC4 can be generated based on the frames Fk-1 and Fk through the operations of the motion estimation and the motion compensation.

Furthermore, the motion estimation can generate a reliability of motion vectors based on one or more information, such as sum of absolute differences (SAD), average luminance, regional motion vector, and global motion vector, related to the motion vectors. After the reliability is calculated, the result of the motion compensation can be adjusted based on reliability (e.g., adjusting the positions of the interpolated frames FC1-FC4 on the timeline).

In some embodiments, a reliability of the whole frame (e.g., the frame Fk-1) will be calculated after the motion estimation, and the reliability calculated will be used for motion compensation. However, due to the limited memory space, the reliability calculated may not able to provide enough information for the motion compensation resulting in inaccurate compensation. Accordingly, adding other compensation method or expanding memory spaces is needed for curing the inaccurate issue. However, when it comes to image processing technology that emphasizes computational cost and efficiency, the aforementioned method may lead to high cost or low efficiency.

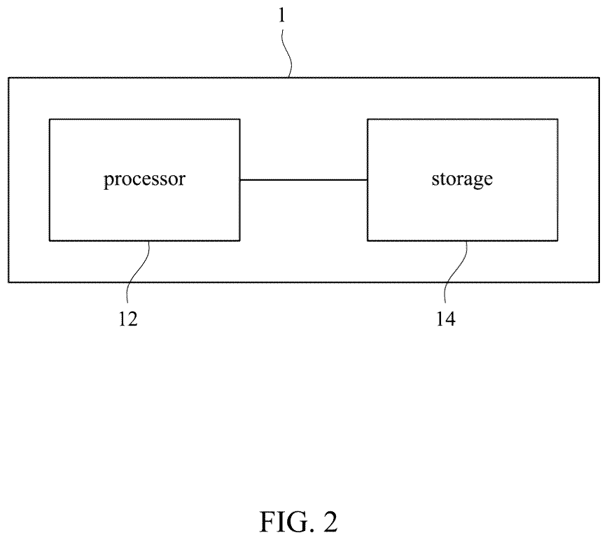

Therefore, the present disclosure provides an image processing apparatus referred in FIG. 2. FIG. 2 is a schematic diagram illustrating an image processing apparatus 1 according to a first embodiment of the present disclosure. As shown in FIG. 2, the image processing apparatus 1 comprises a processor 12 and a storage 14, wherein the processor 12 is coupled to the storage 14.

In some embodiments, the processor 12 can comprise a central processing unit (CPU), a graphics processing unit (GPU), a multi-processor, a distributed processing system, an application specific integrated circuit (ASIC), and/or a suitable processing unit.

In some embodiments, the storage 14 can comprise a semiconductor or solid-state memory, a magnetic tape, a removable computer diskette, a random-access memory (RAM), a read-only memory (ROM), a rigid magnetic disk, and/or an optical disk.

First, the processor 12 of the image processing apparatus 1 downsizes the current frame Fn and the reference frame Ffn to generate multiple down-sized current frames F1-Fn-1 with different resolutions and multiple down-sized reference frame Ff1-Ffn-1 with different resolutions respectively.

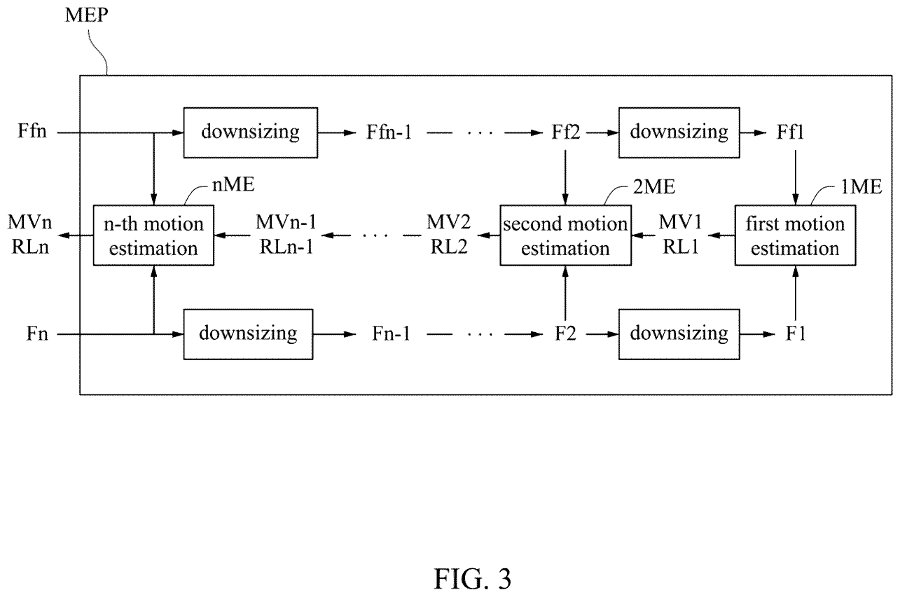

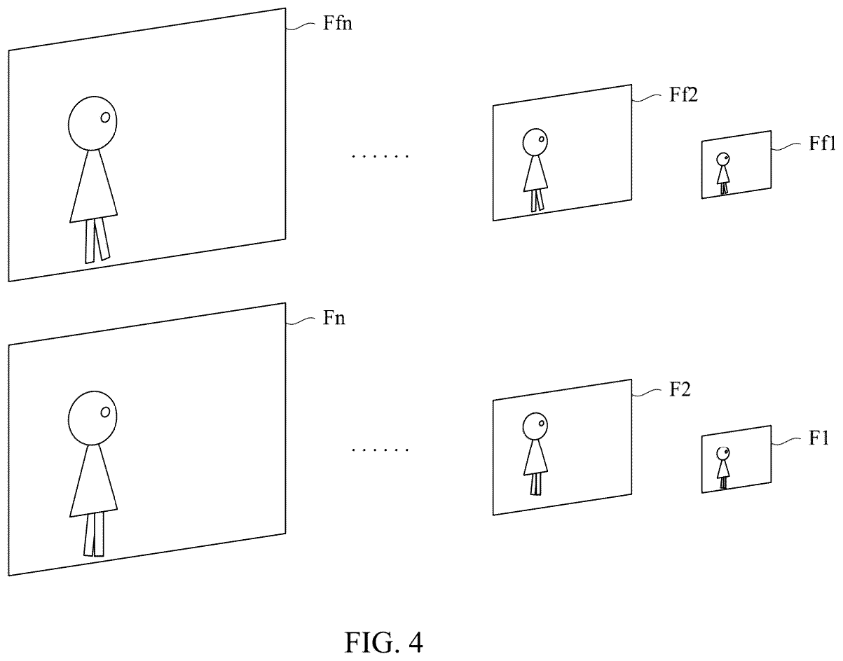

Specifically, please refer to FIG. 3-4. FIG. 3 is a schematic diagram illustrating a motion estimation process MEP according to an embodiment of the present disclosure. FIG. 4 is a schematic diagram illustrating downsizing the frames according to an embodiment of the present disclosure. The frames Fn-1 and Ffn-1 are the frames of the current frame Fn and the reference frame Ffn after being downsized once respectively. By analogy, the frames F1 and Ff1 are the frames of the current frame Fn and the reference frame Ffn after being downsized n−1 times respectively. For example, the downsizing rate can be ½ or ¼, but the present disclosure is not limited thereto. In an embodiment, the current frame Fn is the frame Fk-1 shown in FIG. 1, the reference frame Ffn is the frame Fk shown in FIG. 1. Namely, the current frame Fn and the reference frame Ffn can be two adjacent frames in continuous images (e.g., a video), but the present disclosure is not limited thereto.

The motion estimation process MEP is hierarchical operations, namely, the motion estimation process MEP comprises a first motion estimation 1ME to an n-th motion estimation nME executed sequentially. The processor 12 can perform the first motion estimation 1ME on the frames F1 and Ffn to generate multiple first motion vectors MV1 and a first reliability RL1. More specifically, after the first motion vectors MV1 is calculated, the image processing apparatus 1 can also calculate the first reliability RL1 corresponding to the first motion vectors MV1 based on the related information of the first motion vectors MV1.

In some embodiments, the processor 12 can calculate the first reliability RL1 based on the first motion vectors MV1 and a plurality of sum of absolute differences corresponding to the first motion vectors MV1, wherein the sum of absolute differences and the first reliability RL1 are positively related. For example, the image processing apparatus 1 can calculate the reliability corresponding to motion vectors based on the following formula 1.

$$RL = \sum ( MV speed - base threshold ) * ( SAD value - coring threshold ) * RMV relation * GMV relation , \qquad ( formula 1 )$$

Wherein RL is an reliability (e.g., the first reliability RL1), MV speed is an absolute value of each of the motion vectors (e.g., the first motion vectors MV1), base threshold is a baseline threshold, SAD value is sum of absolute differences, RMV relation is relations between the motion vectors and reginal motion vectors, GMV relation is relations between the motion vectors and global motion vectors, and Σ operator is used for summing up the products calculated based on the motion vectors.

It is noted that, the reginal motion vectors are motion vectors calculated based on pixels in an area formed by multiple adjacent blocks in a frame, and the global motion vectors are motion vectors calculated based on pixels in the whole frame.

Furthermore, the aforementioned GMV relation can be calculated based on one of the three calculation method shown in the following formula 2.

$$GMV relation = ( MV - base\_th1 ) . clip ( min\_value , max\_value ) + ( MV - base\_th2 ) . clip ( min\_value , max\_value ) // 2 \qquad ( formula 2 )$$

$$GMV relation = max ( ( MV - base\_th1 ) . clip ( min\_value , max\_value ) , \\ ( MV - base\_th2 ) . clip ( min\_value , max\_value ) )$$

$$GMV relation = min ( ( MV - base\_th1 ) . clip ( min\_value , max\_value ) , \\ ( MV - base\_th2 ) . clip ( min\_value , max\_value ) ) ,$$

Wherein MV is motion vectors (e.g., one of the first motion vectors MV1), base_th1 and base_th2 are absolute values of global motion vectors having the highest weight and the second highest weight respectively (i.e., absolute values of global motion vectors having the highest reliability and the second highest reliability). The clip function is used for limit the calculated difference of the motion vectors and the global motion vectors between a preset minimum value (i.e., min_value) and a preset maximum value (i.e., max_value). For example, if the difference is less than the preset minimum value, than set the difference as the preset minimum value; and if the difference is greater than the preset maximum value, than set the difference as the preset maximum value. //is a floor division operator (i.e., rounding off the decimal of a quotient calculated after division unconditionally to obtain an integer not greater than the quotient), the max function is used for selecting the maximum value, and the min function is used for selecting the minimum value. Accordingly, GMV relation can be calculated through selecting the mean value, maximum value, or minimum value from the differences between the motion vectors and the global motion vectors with higher weights.

As for base_th1 and base_th2, they can be calculated by the following formula 3.

$$base\_th1 = sum ( abs ( gmv\_ 1 st\_mvx + gmv\_ 1 st\_mvy ) ) \\ base\_th2 = sum ( abs ( gmv\_ 2 nd\_mvx + gmv\_ 2 nd\_mvy ) ) , \qquad ( formula 3 )$$

Wherein gmv_1st_mvx and gmv_2nd_mvx are x-axis components of global motion vectors having the highest weight and the second highest weight respectively, and gmv_1st_mvy and gmv_2nd_mvy are y-axis components of global motion vectors having the highest weight and the second highest weight respectively. The abs function is used for calculating the absolute value, and the sum function is used for calculating the sum value.

On the other hand, the aforementioned RMV relation can also be calculated through a similar method to the GMV relation, and the difference is that RMV relation refers to the motion vectors of the area where the block is located, but GMV relation refers to the motion vectors of the whole frame.

As shown in the formula 1, the reliability is positively related to the absolute value of the motion vectors, the sum of absolute differences, the relation between the motion vectors and the regional motion vectors, and the relation between the motion vectors and the global motion vectors. Namely, the higher the motion vectors, the sum of absolute differences, and/or the relations, the higher the reliability of the motion vectors.

In some embodiments, the reliability can be represented by 8 bits, i.e., an integer between 0 and 255. The higher the value, the higher the reliability of the motion vectors, and the lower the value, the lower the reliability of the motion vectors.

Next, the processor 12 of the image processing apparatus 1 performs a second motion estimation 2ME on the frames F2 and Ff2 based on the first motion vectors MV1 and the first reliability RL1 generated according to the frames F1 and Ff1 with a smaller size to generate multiple second motion vectors MV2 and a second reliability RL2 corresponding to the second motion vectors MV2. For example, the second motion estimation 2ME can take the product of one of the first motion vectors MV1 and the first reliability RL1 as an initial vector corresponding to a block in the frames F2 and Ff2 for the scan operation. Accordingly, the second motion estimation 2ME can refer to the result of the first motion estimation 1ME to speed up the convergence of the second motion vectors MV2.

In some embodiments, the operation of the processor 12 generating the second reliability RL2 further comprises generating an intermediate reliability based on the second motion vectors MV2; and generating the second reliability RL2 based on the first reliability RL1 and the intermediate reliability, wherein the first reliability RL1 and the second reliability RL2 are positively related, and the intermediate reliability and the second reliability RL2 are positively related.

For example, the processor 12 generates the intermediate reliability based on the second motion vectors MV2 and the related information through the operation of generating the first reliability RL1 in the aforementioned embodiment, and then summing the intermediate reliability and the first reliability RL1 or calculating the mean value of the intermediate reliability and the first reliability RL1 to obtain the second reliability RL2.

Accordingly, the processor 12 can refer the first reliability RL1 generated by the first motion estimation 1ME to the second reliability RL2 generated by the second motion estimation 2ME.

In some embodiments, the operation of the processor 12 generating the second reliability RL2 further comprises calculating a plurality of matching degrees of a plurality of candidate vectors (e.g., zero, spatial, time, and global vectors); and taking one of the candidate vectors corresponding to a highest matching degree of the matching degrees as one of the second motion vectors MV2. The operation of calculating the matching degrees further comprises calculating a vector difference between one of the candidate vectors and one of the first motion vectors MV1 corresponding to the one of the candidate vectors; calculating a punish value based on the vector difference and the first reliability RL1, wherein the punish value is positively related to the vector difference and the first reliability RL1; and reducing one of the matching degrees of the one of the candidate vectors based on the punish value.

For example, the processor 12 can subtract each of the candidate vectors and the corresponding first motion vectors MV1 respectively to obtain the vector difference, and then multiplying the vector difference by the first reliability RL1 to obtain the punish value corresponding to each of the candidate vectors. In summary, the punish value will reflect the difference between the candidate vectors and the corresponding first motion vectors MV1 and also the first reliability RL1 of the first motion vectors MV1.

Furthermore, the processor 12 will reduce the matching degree of each of the candidate vectors based on the corresponding punish value. For example, if the absolute values of the differences between the candidate vectors and the first motion vectors MV1 are relatively higher, it indicates that the candidate vectors are less matching the result of the first motion estimation 1ME, then the processor 12 will greatly reduce the matching degree based on the higher punish value. On the other hand, if the reliability corresponding to the first motion vectors MV1 are relatively higher, it indicates that the result of the first motion estimation 1ME has a relatively higher reliability, then the processor 12 will also greatly reduce the matching degree based on the higher punish value. In summary, the processor 12 will reduce the matching degrees of the candidate vectors based on the absolute values of the vector differences and the reliability to reflect the result of the first motion estimation 1ME.

In some embodiments, as the aforementioned 3D recursive searching operation, the second motion estimation 2ME comprises multiple scan operations, wherein the scan operations further comprises the processor 12 calculating a searching window size of the second motion estimation 2ME based on the first reliability RL1; and the processor 12 generating a plurality of candidate vectors in a searching window having the searching window size.

Specifically, the processor 12 can adjust the range of the searching for the candidate vectors in frames in the 3D recursive searching operation based on the reliability. In some embodiments, the processor 12 can obtain a searching window size corresponding to the reliability based on a reference table, wherein the reference table can be stored in the storage 14 and record searching window sizes corresponding to different reliability values. For example, when the reliability is a value between 0 and 32, the corresponding searching window size is 5*5 pixels.

In some embodiments, the processor 12 can calculate the searching window size of the second motion estimation 2ME based on a reliability (e.g., the first reliability RL1) and the following formula 4.

$$search step = ( original search step * reliability level ) ≫ reliability level bit number , \qquad ( formula 4 )$$

Wherein the search step is the searching window size, the original search step is a preset searching window size (e.g., 3*3 pixels), the reliability level is the reliability (e.g., the first reliability RL1), the reliability level bit number is a number of reliability bits (e.g., 8), and the >>operator indicates shifting the bits to the right.

According to the formula 4 above, the processor 12 can adjust the degree of the reduction of the searching window size based on the reliability, wherein the higher the reliability, the closer the searching window size is to the preset searching window size and not to be reduced; in contrast, the lower the reliability, the greater the searching window size being reduced.

In some embodiments, the processor 12 can also calculate the searching window size based on the reliability (e.g., the first reliability RL1) and the following formula 5.

$$search step = ( original search step * \qquad ( formula 5 )$$

$$( max reliability level - reliability level ) ) ≫ reliability level bit number ,$$

Wherein the search step is the searching window size, the original search step is a preset searching window size (e.g., 3*3 pixels), the max reliability level is a maximum value of the reliability (e.g., 255), the reliability level is the reliability (e.g., the first reliability RL1), and the reliability level bit number is a number of reliability bits (e.g., 8).

According to the formula 5 above, the processor 12 can adjust the degree of the reduction of the searching window size based on the reliability. The lower the reliability, the closer the searching window size is to the preset searching window size and not to be reduced; in contrast, the lower the reliability, the greater the searching window size being reduced.

Accordingly, the processor 12 can adjust the searching window size based on the reliability, thereby adjusting the convergence speed of motion vectors during performing the motion estimation based on the reliability generated in the previous motion estimation. Additionally, in the embodiment for calculating the searching window size by the formula 4 and 5, the reliability is linearly related to the searching window size.

Next, the processor 12 performs a third motion estimation 3ME on the frames F3 and Ff3 based on the second motion vectors MV2 and the second reliability RL2 generated in the second motion estimation 2ME. The calculation process of the third motion estimation 3ME can be the same as the one of the second motion estimation 2ME. The difference between them is the data used are different, e.g., the third motion estimation 3ME is performed by using the frames F3 and Ff3, the second motion vectors MV2, and the second reliability RL2. By analogy, the processor 12 can also perform motion estimations on the frames F1-Fn and Ff1-Ffn with different sizes by using the same process. After the n-th motion estimation is executed, the processor 12 generates n-th motion vectors MVn and an n-th reliability RLn corresponding to the current frame Fn and the reference frame Ffn.

It is noted that, n can be a positive integer greater than 1, and the image processing apparatus 1 can adjust the number of times to downsize the current frame Fn and the reference frame Ffn and the layers in the motion estimation process MEP referring to the computational cost and efficiency.

After finishing the motion estimation process MEP on the current frame Fn and the reference frame Ffn, the processor 12 of the image processing apparatus 1 is configured to perform a motion compensation on the current frame Fn and the reference frame Ffn based on the n-th motion vectors MVn and the n-th reliability RLn to generate one or more compensated frame between the current frame Fn and the reference frame Ffn. When executing the motion compensation, the processor 12 will refer to the n-th reliability RLn to adjust the involvement degree of the n-th motion vectors MVn. Namely, when generating the compensated frame based on the n-th motion vectors MVn, the processor 12 will adjust the weight of the n-th motion vectors MVn according to the n-th reliability RLn. The higher the n-th reliability RLn, the higher the weight of the n-th motion vectors MVn to generate the compensated frame; in contrast, the lower the n-th reliability RLn, the lower the weight of the n-th motion vectors MVn to generate the compensated frame.

In some embodiments, please refer to FIG. 1, the compensation target of the compensated frames FC1-FC2 is the frame Fk-1, thus, time differences Din1 and Din2 between the compensated frames FC1-FC2 and the frame Fk-1 are less than time differences between the compensated frames FC1-FC2 and the frame Fk. The compensation target of the compensated frames FC3-FC4 is the frame Fk, thus, time differences Din3 and Din4 between the compensated frames FC3-FC4 and the frame Fk are less than time differences between the compensated frames FC3-FC4 and the frame Fk-1.

Similarly, please refer to FIG. 2 again, when executing the motion compensation, the processor 12 can select the frame Fn or Ffn as a compensation target and calculate one or more compensated frame based on the following formula 6 correspondingly.

$$motion compensation output = ( z data * ( max reliability level - RLn ) + mc data * reliability level ) ≫ reliability level bit number , \qquad ( formula 6 )$$

Wherein the motion compensation output is the compensated frame, the z data is the compensation target (e.g., the frame Fn), the max reliability level is the maximum value of the reliability (e.g., 255), motion compensation data is an original compensated frame preliminarily calculated based on the motion vectors (e.g., the n-th motion vectors MVn) by the processor 12 and not yet been adjusted based on the reliability, and the reliability level bit number is a number of reliability bits (e.g., 8).

The greater the difference between the maximum value of the reliability and the n-th reliability RLn, the higher the visual similarity between the compensated frame and the compensation target. That is, if the n-th reliability RLn is relatively lower, it indicates that the n-th motion vectors are less reliable, thus, the compensation degree can be reduced to make the compensated frame to be more similar with the compensation target; in contrast, if the n-th reliability RLn is relatively higher, it indicates that the n-th motion vectors are more reliable, thus, the compensation degree can be increased to make the visual difference between the compensated frame and the compensation target greater.

In summary, the motion compensation comprises the processor 12 selecting one of the current frame Fn and the reference frame Ffn as a compensation target; and the processor 12 generating a compensated frame corresponding to the compensation target based on the compensation target, the n-th reliability RLn, and the n-th motion vectors MVn, wherein the n-th reliability RLn is negatively related to a similarity between the compensated frame and the compensation target.

In some embodiments, when executing the motion compensation, in addition to determining the visual similarity between the compensated frame and the compensation target by using the formula 6, the processor 12 also determines the time differences between each of the compensated frames and the compensation target based on the n-th reliability RLn by using the following formula 7. More specifically, there is an initial time difference between the compensation target and each of the compensated frames calculated by using the aforementioned formula 6, and the initial time difference is related to the number of the compensated frame. For example, as shown in FIG. 1, if 4 compensated frames FC1-FC4 is expected to be generated, then the time difference between the frames Fk-1 and Fk can be divided by 5 to obtain the time differences Din1-Din4 corresponding to the compensated frames FC1-FC4 respectively (assumes that the time differences Din1-Din4 have not been adjusted after generated in the motion compensation). Similarly, please refer to FIG. 2 again, when executing the motion compensation, the processor 12 can further adjust the initial time difference of each of the compensated frames by using the following formula 7 to obtain the adjusted time difference of each of the compensated frames.

$$adjust value = \vert original phase - phase boundary \vert \times \frac{RLn}{R} , \qquad ( formula 7 )$$

Wherein the original phase is the initial time difference, the phase boundary is the boundary of the compensated frame. For example, if 128 compensated frames are expected to be inserted between the current frame Fn and the reference frame Ffn, the 0th to the 63th compensated frames are closer to the current frame Fn and correspond to the boundary 0, and the 64th to the 127th compensated frames are closer to the reference frame Ffn and correspond to the boundary 128. The adjust value is an adjustment value of the initial time difference, and R is the maximum value of the reliability (e.g., 255).

The processor 12 will move the compensated frames towards the compensation target on a timeline based on the adjustment value to achieve the adjusted time differences of the compensated frames. Following the embodiment of inserting 128 compensated frames between the current frame Fn and the reference frame Ffn, when the processor 12 calculates that the initial time difference, the reliability, and the adjustment value are 32, 64, and 8 respectively, since the compensation target corresponding to the compensated frame is the current frame Fn (i.e., corresponding to the boundary 0), the adjusted time difference of the compensated frame can be calculated as the boundary plus the adjustment value, i.e., 8.

In another example, when calculating the original phase of the compensated frame as 80 and the reliability as 128, the processor 12 can obtain the adjustment value as 24 by using the formula 7. Furthermore, since the compensation target corresponding to the compensated frame is the reference frame Ffn (i.e., corresponding to the boundary 128), the adjusted time difference of the compensated frame can be calculated as the boundary minus the adjustment value, i.e., 104.

In summary, the processor 12 is configured to calculate an adjustment value based on the initial time difference and the n-th reliability RLn corresponding to the n-th motion vectors, wherein the n-th reliability RLn and the adjustment value are negatively related; and adjust the initial time difference based on the adjustment value to determine an adjusted time difference between the compensated frame and the current frame Fn or the reference frame Ffn.

Accordingly, the processor 12 can adjust the inserting position of the compensated frame between the current frame Fn and the reference frame Ffn based on the reliability. The formula 7 is configured to adjust the inserting position of each of the compensated frame based on the ratio between the n-th reliability RLn and the maximum reliability. The higher the n-th reliability RLn, the less the adjustment value. In contrast, the lower the n-th reliability RLn, the greater the adjustment value. That is, if the n-th reliability RLn is relatively higher, it indicates that the quality of the compensated frame generated by the n-th motion vectors is relatively higher, thus, the compensation degree can be increased by increasing the time difference between the compensated frame and the compensation target. In contrast, if the n-th reliability RLn is relatively lower, it indicates that the quality of the compensated frame generated by the n-th motion vectors is relatively lower, thus, the compensation degree can be reduced by reducing the time difference between the compensated frame and the compensation target.

In summary, the image processing apparatus 1 of the present disclosure is configured to execute the hierarchical motion estimation process MEP, wherein each of the layer of the motion estimations will refer to the motion vectors and the reliability generated by the previous motion estimation. Accordingly, the image processing apparatus 1 can adjust the involvement degree (e.g., weight) of the motion vectors to the next motion estimation based on the reliability and improve the efficiency and accuracy of motion estimations to calculate the motion vectors. Additionally, the image processing apparatus 1 can also take the n-th reliability RLn generated by the motion estimation process MEP as a reference for generating a compensated frame in the motion compensation. Similarly, the image processing apparatus 1 can adjust the involvement degree (e.g., weight) of the motion vectors to the motion compensation based on the reliability of the motion vectors. Therefore, while maintaining or reducing the computational cost, the image processing apparatus 1 of the present disclosure can also avoid the image broken, edge shaking, or judder in frames.

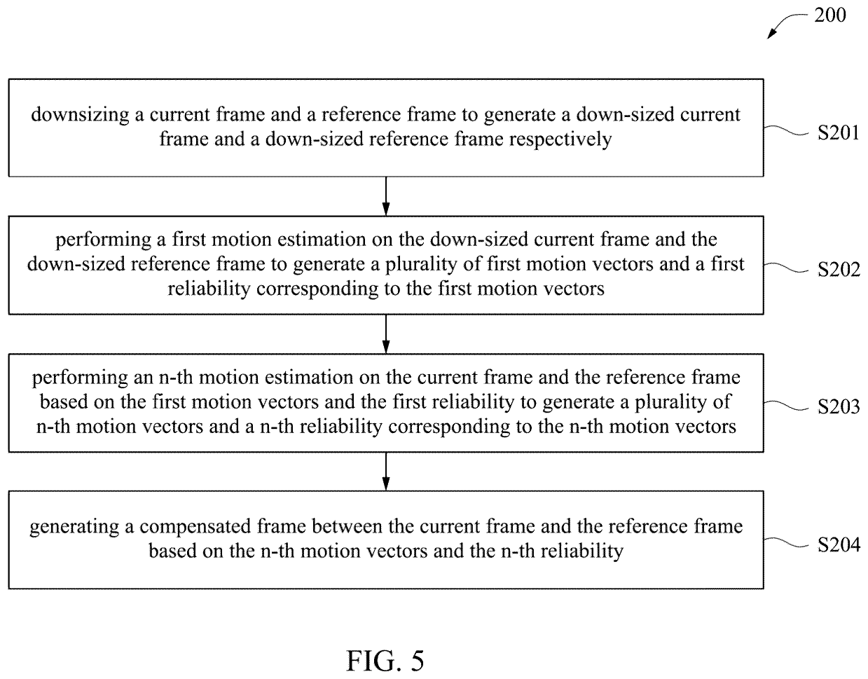

The present disclosure also provides an image processing method, please refer to FIG. 5. FIG. 5 is a flow diagram illustrating an image processing method the image processing method 200 according to a second embodiment of the present disclosure. The image processing method 200 is adapted for use in an electronic apparatus (e.g., the image processing apparatus 1). In some embodiments, the electronic apparatus comprises a storage (e.g., the storage 14) and a processor (e.g., the processor 12). The storage is configured to store a current frame and a reference frame. The processor is coupled to the storage, and the processor is configured to execute the image processing method 200.

The image processing method 200 comprises steps S201-S204. In the step S201, the electronic apparatus downsizes a current frame and a reference frame to generate a down-sized current frame and a down-sized reference frame respectively.

In the step S202, the electronic apparatus performs a first motion estimation on the down-sized current frame and the down-sized reference frame to generate a plurality of first motion vectors and a first reliability corresponding to the first motion vectors.

In the step S203, the electronic apparatus performs an n-th motion estimation on the current frame and the reference frame based on the first motion vectors and the first reliability to generate a plurality of n-th motion vectors and a n-th reliability corresponding to the n-th motion vectors.

In the step S204, the electronic apparatus generates a compensated frame between the current frame and the reference frame based on the n-th motion vectors and the n-th reliability.

In some embodiments, the step S202 further comprises the electronic apparatus calculating the first reliability based on the first motion vectors and a plurality of sum of absolute differences corresponding to the first motion vectors, wherein the sum of absolute differences and the first reliability are positively related.

In some embodiments, the step S202 further comprises the electronic apparatus calculating the first reliability based on a regional motion vector, a global motion vector, the first motion vectors, and the sum of absolute differences, wherein a first relation between the first motion vectors and the regional motion vector and the first reliability are positively related, and a second relation between the first motion vectors and the global motion vector and the first reliability are positively related.

In some embodiments, the step S203 further comprises the electronic apparatus generating an intermediate reliability based on the n-th motion vectors; and the electronic apparatus generating the n-th reliability based on the first reliability and the intermediate reliability, wherein the first reliability and the n-th reliability are positively related, and the intermediate reliability and the n-th reliability are positively related.

In some embodiments, the step S203 further comprises the electronic apparatus calculating a plurality of matching degrees of a plurality of candidate vectors; and the electronic apparatus taking one of the candidate vectors corresponding to a highest matching degree of the matching degrees as one of the n-th motion vectors.

In some embodiments, the step of calculating the matching degrees further comprises the electronic apparatus calculating a vector difference between one of the candidate vectors and one of the first motion vectors corresponding to the one of the candidate vectors; the electronic apparatus calculating a punish value based on the vector difference and the first reliability, wherein the punish value is positively related to the vector difference and the first reliability; and the electronic apparatus reducing one of the matching degrees of the one of the candidate vectors based on the punish value.

In some embodiments, the n-th motion estimation comprises a plurality of scan steps, and the scan steps comprise the electronic apparatus calculating a searching window size based on the first reliability, wherein the first reliability is linearly related to the searching window size; and the electronic apparatus generating a plurality of candidate vectors in a searching window having the searching window size.

In some embodiments, the step S204 further comprises the electronic apparatus selecting one of the current frame and the reference frame as a compensation target; and the electronic apparatus performing a motion compensation based on the compensation target, the n-th reliability, and the n-th motion vectors to generate the compensated frame corresponding to the compensation target, wherein the n-th reliability is negatively related to a similarity between the compensated frame and the compensation target.

In some embodiments, there is an initial time difference between the compensated frame and the compensation target, and the image processing method 200 further comprises the electronic apparatus calculating an adjustment value based on the initial time difference and the n-th reliability, wherein the n-th reliability and the adjustment value are negatively related; and the electronic apparatus adjusting the initial time difference based on the adjustment value to determine an adjusted time difference between the compensated frame and the compensation target.

In some embodiments, the step of determining the adjusted time difference comprises the electronic apparatus moving the compensated frame towards the compensation target on a timeline.

In some embodiments, the image processing method 200 further comprises the electronic apparatus downsizing the down-sized current frame and the down-sized reference frame to generate a second down-sized current frame and a second down-sized reference frame respectively; and the electronic apparatus performing a third motion estimation on the second down-sized current frame and the second down-sized reference frame to generate a plurality of third motion vectors and a third reliability corresponding to the third motion vectors, wherein the operation of performing the first motion estimation further comprises generating the first motion vectors and the first reliability based on the third reliability.

In summary, the image processing method 200 of the present disclosure can take the result of the motion estimation on smaller size frames as a reference for the motion estimation on larger size frames. In addition to the motion vectors, the reliability of the motion vectors is also taken as the reference. Accordingly, the image processing method 200 can adjust the involvement degree (e.g., weight) of the motion vectors to the next motion estimation based on the reliability of the motion vectors and improve the efficiency and accuracy of motion estimations to calculate the motion vectors. Additionally, the image processing method 200 can also use the reliability of the motion vectors as a reference for generating a compensated frame in the motion compensation. Similarly, the image processing method 200 can adjust the involvement degree (e.g., weight) of the motion vectors to the motion compensation based on the reliability of the motion vectors. Therefore, while maintaining or reducing the computational cost, the image processing method 200 of the present disclosure can also avoid the image broken, edge shaking, or judder in frames.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An image processing apparatus, comprising:
a storage, configured to store a current frame and a reference frame; and
a processor, coupled to the storage, configured to execute the following operations:
downsizing the current frame and the reference frame to generate a down-sized current frame and a down-sized reference frame respectively;
performing a first motion estimation on the down-sized current frame and the down-sized reference frame to generate a plurality of first motion vectors and a first reliability corresponding to the first motion vectors;
performing an n-th motion estimation on the current frame and the reference frame based on the first motion vectors and the first reliability to generate a plurality of n-th motion vectors and a n-th reliability corresponding to the n-th motion vectors; and
generating a compensated frame between the current frame and the reference frame based on the n-th motion vectors and the n-th reliability.

2. The image processing apparatus of claim 1, wherein the operation of performing the first motion estimation comprises:
calculating the first reliability based on the first motion vectors and a plurality of sum of absolute differences corresponding to the first motion vectors, wherein the sum of absolute differences and the first reliability are positively related.

3. The image processing apparatus of claim 2, wherein the operation of calculating the first reliability based on the first motion vectors and the sum of absolute differences comprises:
calculating the first reliability based on a regional motion vector, a global motion vector, the first motion vectors, and the sum of absolute differences, wherein a first relation between the first motion vectors and the regional motion vector and the first reliability are positively related, and a second relation between the first motion vectors and the global motion vector and the first reliability are positively related.

4. The image processing apparatus of claim 1, wherein the operation of performing the n-th motion estimation comprises:
generating an intermediate reliability based on the n-th motion vectors; and
generating the n-th reliability based on the first reliability and the intermediate reliability, wherein the first reliability and the n-th reliability are positively related, and the intermediate reliability and the n-th reliability are positively related.

5. The image processing apparatus of claim 1, wherein the operation of performing the n-th motion estimation comprises:
calculating a plurality of matching degrees of a plurality of candidate vectors; and
taking one of the candidate vectors corresponding to a highest matching degree of the matching degrees as one of the n-th motion vectors.

6. The image processing apparatus of claim 5, wherein the operation of calculating the matching degrees comprises:
calculating a vector difference between one of the candidate vectors and one of the first motion vectors corresponding to the one of the candidate vectors;
calculating a punish value based on the vector difference and the first reliability, wherein the punish value is positively related to the vector difference and the first reliability; and
reducing one of the matching degrees of the one of the candidate vectors based on the punish value.

7. The image processing apparatus of claim 1, wherein the n-th motion estimation comprises a plurality of scan operations, and the scan operations comprise:
calculating a searching window size based on the first reliability, wherein the first reliability is linearly related to the searching window size; and
generating a plurality of candidate vectors in a searching window having the searching window size.

8. The image processing apparatus of claim 1, wherein the operation of generating the compensated frame comprises:
selecting one of the current frame and the reference frame as a compensation target; and
performing a motion compensation based on the compensation target, the n-th reliability, and the n-th motion vectors to generate the compensated frame corresponding to the compensation target, wherein the n-th reliability is negatively related to a similarity between the compensated frame and the compensation target.

9. The image processing apparatus of claim 8, wherein there is an initial time difference between the compensated frame and the compensation target, and the processor is further configured to:
calculating an adjustment value based on the initial time difference and the n-th reliability, wherein the n-th reliability and the adjustment value are negatively related; and
adjusting the initial time difference based on the adjustment value to determine an adjusted time difference between the compensated frame and the compensation target.

10. The image processing apparatus of claim 9, wherein the operation of determining the adjusted time difference comprises:
moving the compensated frame towards the compensation target on a timeline.

11. An image processing method, being adapted for use in an electronic apparatus, wherein the image processing method comprises the following steps:
downsizing a current frame and a reference frame to generate a down-sized current frame and a down-sized reference frame respectively;
performing a first motion estimation on the down-sized current frame and the down-sized reference frame to generate a plurality of first motion vectors and a first reliability corresponding to the first motion vectors;
performing an n-th motion estimation on the current frame and the reference frame based on the first motion vectors and the first reliability to generate a plurality of n-th motion vectors and a n-th reliability corresponding to the n-th motion vectors; and
generating a compensated frame between the current frame and the reference frame based on the n-th motion vectors and the n-th reliability.

12. The image processing method of claim 11, wherein the step of performing the first motion estimation comprises:
calculating the first reliability based on the first motion vectors and a plurality of sum of absolute differences corresponding to the first motion vectors, wherein the sum of absolute differences and the first reliability are positively related.

13. The image processing method of claim 12, wherein the step of calculating the first reliability based on the first motion vectors and the sum of absolute differences comprises:
calculating the first reliability based on a regional motion vector, a global motion vector, the first motion vectors, and the sum of absolute differences, wherein a first relation between the first motion vectors and the regional motion vector and the first reliability are positively related, and a second relation between the first motion vectors and the global motion vector and the first reliability are positively related.

14. The image processing method of claim 11, wherein the step of performing the n-th motion estimation comprises:
generating an intermediate reliability based on the n-th motion vectors; and
generating the n-th reliability based on the first reliability and the intermediate reliability, wherein the first reliability and the n-th reliability are positively related, and the intermediate reliability and the n-th reliability are positively related.

15. The image processing method of claim 11, wherein the step of performing the n-th motion estimation comprises:
calculating a plurality of matching degrees of a plurality of candidate vectors; and
taking one of the candidate vectors corresponding to a highest matching degree of the matching degrees as one of the n-th motion vectors.

16. The image processing method of claim 15, wherein the step of calculating the matching degrees comprises:
calculating a vector difference between one of the candidate vectors and one of the first motion vectors corresponding to the one of the candidate vectors;
calculating a punish value based on the vector difference and the first reliability, wherein the punish value is positively related to the vector difference and the first reliability; and
reducing one of the matching degrees of the one of the candidate vectors based on the punish value.

17. The image processing method of claim 11, wherein the n-th motion estimation comprises a plurality of scan steps, and the scan steps comprise:
calculating a searching window size based on the first reliability, wherein the first reliability is linearly related to the searching window size; and
generating a plurality of candidate vectors in a searching window having the searching window size.

18. The image processing method of claim 11, wherein the step of generating the compensated frame comprises:
selecting one of the current frame and the reference frame as a compensation target; and
performing a motion compensation based on the compensation target, the n-th reliability, and the n-th motion vectors to generate the compensated frame corresponding to the compensation target, wherein the n-th reliability is negatively related to a similarity between the compensated frame and the compensation target.

19. The image processing method of claim 18, wherein there is an initial time difference between the compensated frame and the compensation target, and the image processing method further comprises:
calculating an adjustment value based on the initial time difference and the n-th reliability, wherein the n-th reliability and the adjustment value are negatively related; and
adjusting the initial time difference based on the adjustment value to determine an adjusted time difference between the compensated frame and the compensation target.

20. The image processing method of claim 19, wherein the step of determining the adjusted time difference comprises:
moving the compensated frame towards the compensation target on a timeline.
